(19) United States
(12) Patent Application Publication
(10) Pub. No.: US 2023/0304600 A1
(43) Pub. Date: Sep. 28, 2023

(54) TORQUE LIMITING HANDLE

(71) Applicant: ENTEGRIS, INC., Billerica, MA (US)

(72) Inventors: Sanado Barolli, Bethlehem, CT (US); Sarah Ann Utz, Rochester, NY (US); Tim M. Dwyer, Danbury, CT (US)

(21) Appl. No.: 18/126,019

(22) Filed: Mar. 24, 2023

Related U.S. Application Data
(60) Provisional application No. 63/323,769, filed on Mar. 25, 2022.

(51) Int. Cl. F16K 31/60; F16D 43/202; F16D 7/04

(52) U.S. Cl. CPC F16K 31/607; F16D 7/048; F16D 43/2028; F16D 2121/14; F16D 2200/0034

(57) ABSTRACT

A handle includes a torque limiting device. The torque limiting device includes a plurality of driven members and a plurality of driving members. The plurality of driving members is configured to drive the plurality of driven members in a first direction to turn a valve. In response to turning the valve, the plurality of driving members disengages from the plurality of driven members upon reaching a torque threshold. Feedback is provided when the torque limiting device reaches the torque threshold.

### FIELD

This disclosure relates generally to a handle for a fluid container. More particularly, this disclosure relates to a handle including a torque limiting device for opening and closing a valve of a fluid container or a gas vessel.

### BACKGROUND

Cylinders for storing and dispensing fluids and gases generally have a valve to enable or disable flow of the fluid into or out of the cylinder. The valves typically have a specific closing torque range that an end user is supposed to use. Sometimes no torque device is used and sometimes the wrong one is used. The valve may not be properly opened or closed or can be opened or closed too far, damaging the valve and shortening its lifetime.

### SUMMARY

In some embodiments, a handle includes a torque limiting device. In some embodiments, the torque limiting device includes a plurality of driven members and a plurality of driving members. In some embodiments, the plurality of driving members is configured to drive the plurality of driven members in a first direction to turn a valve. In some embodiments, in response to turning the valve, the plurality of driving members disengages from the plurality of driven members upon reaching a torque threshold. In some embodiments, feedback is provided when the torque limiting device reaches the torque threshold.

In some embodiments, the handle is configured to be turned in the first direction to close the valve and to be turned in a second direction to open the valve. In some embodiments, the handle includes an indicator configured to visually indicate a position of the valve.

In some embodiments, the handle includes an outer body and an inner body. In some embodiments, the outer body and the inner body are configured to be joined together. In some embodiments, the inner body is configured to be secured within the outer body. In some embodiments, the outer body includes the plurality of driving members and the inner body includes the plurality of driven members. In some embodiments, the outer body includes the plurality of driven members and the inner body includes the plurality of driving members. In some embodiments, one or more of the outer body and the inner body are made of a non-metal material. In some embodiments, the outer body has an inner diameter, and the inner body has an outer diameter. In some embodiments, the inner diameter is larger than the outer diameter so that the inner body fits within the outer body. In some embodiments, the plurality of driven members includes a plurality of members extending from a hub of the inner body.

In some embodiments, a geometry and stiffness of the plurality of driving members are defined to cause the plurality of driving members to be disengaged from the plurality of driven members upon reaching the torque threshold.

In some embodiments, a system includes a fluid or gas container or vessel, a valve, and a handle. In some embodiments, the valve has a first position in which flow from the fluid container is enabled. In some embodiments, the valve has a second position in which flow from the fluid container is disabled. In some embodiments, the handle is configured to be turned in a first direction to open the valve and to be turned in a second direction to close the valve. In some embodiments, the handle includes a plurality of driven members and a plurality of driving members. In some embodiments, the plurality of driving members is configured to drive the plurality of driven members in a first direction to turn a valve. In some embodiments, in response to turning the valve, the plurality of driving members disengages from the plurality of driven members upon reaching a torque threshold. In some embodiments, feedback is provided when the torque threshold is reached.

In some embodiments, the system includes an indicator configured to visually indicate a position of the valve.

In some embodiments, the system includes a scannable indicator configured to denote a fluid type of the fluid container. In some embodiments, the handle includes the scannable indicator.

In some embodiments, one or more of the plurality of driving members and the plurality of driven members are made of a non-metal material.

In some embodiments, the handle further includes an outer body and an inner body. In some embodiments, the outer body and the inner body are configured to be joined together. In some embodiments, the inner body configured to be secured within the outer body. In some embodiments, the outer body has an inner diameter, and the inner body has an outer diameter. In some embodiments, the inner diameter is larger than the outer diameter so that the outer body fits over the inner body.

In some embodiments, a geometry and stiffness of the plurality of driving members are defined to cause the plurality of driving members to be disengaged from the plurality of driven members upon reaching the torque threshold.

In some embodiments, the plurality of driven members includes a plurality of members extending from a hub of the handle.

In some embodiments, the handle includes a protrusion. In some embodiments, at least one of the valve and the fluid container includes a second protrusion. In some embodiments, the second protrusion is configured to limit an amount of rotation in the first direction through abutment with the protrusion of the handle.

In some embodiments, a force applied by the plurality of driving members to the plurality of driven members is configured to be different in the first direction than the second direction.

### BRIEF DESCRIPTION OF THE DRAWINGS

References are made to the accompanying drawings that form a part of this disclosure and that illustrate embodiments in which the systems and methods described in this Specification can be practiced.

FIG. 1 shows a perspective view of a handle, according to some embodiments.

FIG. 2 shows a bottom view of the handle of FIG. 1, according to some embodiments.

FIG. 3 shows an exploded perspective view of the handle of FIG. 1, according to some embodiments.

FIG. 4 shows a perspective view of the handle of FIG. 1 installed on a valve, according to some embodiments.

FIG. 5 shows a side sectional view of the handle of FIG. 1 installed on a valve, according to some embodiments.

FIG. 6 shows a perspective view of a handle, according to some embodiments.

FIG. 7 shows a perspective view of the handle of FIG. 6 with a cover removed, according to some embodiments.

FIG. 8 shows a top view of the handle of FIG. 6 with the cover removed, according to some embodiments.

FIG. 9 shows the handle in FIG. 1 on a fluid storage and dispensing vessel, according to some embodiments.

Like reference numbers represent the same or similar parts throughout.

### DETAILED DESCRIPTION

Cylinders for storing and in some cases, dispensing, fluids and gases generally have a valve to enable or disable flow of the fluid or gas into or out of the cylinder. The valves typically have a specific closing torque range that an end user is supposed to use. Sometimes no torque device is used and sometimes the wrong one is used. The valve may not be properly opened or closed or can be opened or closed too far, damaging the valve and shortening its lifetime.

Embodiments of this disclosure relate to a handle including a torque limiting device. The handle is configured so that upon reaching a torque threshold, a portion of the handle disengages and is no longer able to provide enough torque to rotate a valve. In some embodiments, when the handle disengages, feedback is provided to the user that is either audible or tactile to indicate to a user that the valve is in its opened or closed position. In some embodiments, the handle can prevent a user from over rotating the valve and causing damage. In some embodiments, the handle can increase a lifetime of a valve.

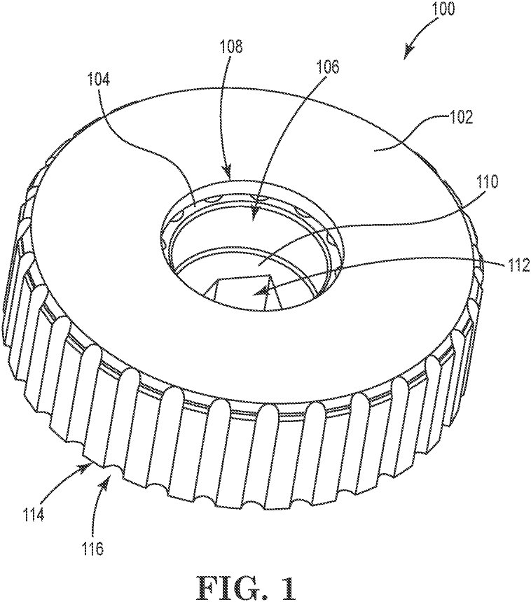

FIG. 1 shows a perspective view of a handle 100, according to some embodiments. The handle 100 can be referred to as a torque limiting handle, according to some embodiments. The handle includes a torque limiting device. The torque limiting device is configured to prevent a user from over torquing a valve when the handle 100 is used with a valve.

The handle 100 includes an outer body 102 and an inner body 104. In the illustrated embodiment, the outer body 102 is configured to at least partially surround the inner body 104.

The inner body 104 includes a hub 106. The hub 106 of the inner body 104 is configured to be secured to a valve. The outer body 102 also includes a hub 108. The hub 106 and the hub 108 can have a similar or same size. In some embodiments, the hub 106 and the hub 108 can be concentric.

The hub 106 of the inner body 104 includes a surface 110 and an opening 112 formed in the surface 110. In some embodiments, the surface 110 can be a planar surface. In some embodiments, the opening 112 can be sized and shaped to receive a threaded bolt from a valve to secure the handle 100 to the valve. In some embodiments, a nut or other fastener can be threaded to the corresponding bolt and subsequently secure the handle 100 to the valve. In some embodiments, the nut can be in direct contact with the surface 110 to provide a clamping force to hold the inner body 104 and the handle 100 to the valve. In some embodiments, the nut can be indirectly in contact with the surface 110 to provide the clamping force.

In some embodiments, the outer body 102 is configured to be secured to the inner body 104 via an interference fit. The outer body 102 is rotatable relative to the inner body 104 in some situations. For example, when the handle 100 is turned to close a valve, the outer body 102 may disengage from the inner body 104 upon reaching a torque threshold. In some embodiments, the torque threshold can be selected based on a particular valve being used with the handle 100. In some embodiments, the torque threshold can be based on an acceptable range of torques for a variety of valves. That is, in some embodiments, the handle 100 can be configured for a specific valve and in some embodiments the handle 100 can be configured for a series of valves. In some embodiments, when the torque threshold is reached, feedback can be provided to the user. For example, in some embodiments audible feedback can be provided. In some embodiments, tactile feedback can be provided. In some embodiments, the feedback can be both audible and tactile.

In some embodiments, the torque threshold can be 7 N•m. In some embodiments, the torque threshold can be 0.1 N•m to 20 N•m; 1 N•m to 20 N•m; 2 N•m to 20 N•m; 3 N•m to 20 N•m; 4 N•m to 20 N•m; 5 N•m to 20 N•m; 6 N•m to 20 N•m; 7 N•m to 20 N•m; 8 N•m to 20 N•m; 9 N•m to 20 N•m; 10 N•m to 20 N•m; 11 N•m to 20 N•m; 12 N•m to 20 N•m; 13 N•m to 20 N•m; 14 N•m to 20 N•m; 15 N•m to 20 N•m; 16 N•m to 20 N•m; 17 N•m to 20 N•m; 18 N•m to 20 N•m; 19 N•m to 20 N•m; 0.1 N•m to 19 N•m; 0.1 N•m to 18 N•m; 0.1 N•m to 17 N•m; 0.1 N•m to 16 N•m; 0.1 N•m to 15 N•m; 0.1 N•m to 14 N•m; 0.1 N•m to 13 N•m; 0.1 N•m to 12 N•m; 0.1 N•m to 11 N•m; 0.1 N•m to 10 N•m; 0.1 N•m to 9 N•m; 0.1 N•m to 8 N•m; 0.1 N•m to 7 N•m; 0.1 N•m to 6 N•m; 0.1 N•m to 5 N•m; 0.1 N•m to 4 N•m; 0.1 N•m to 4 N•m; 0.1 N•m to 3 N•m; 0.1 N•m to 2 N•m; or 0.1 N•m to 1 N•m.

In the illustrated embodiment, the outer body 102 includes a series of protrusions 114 alternating with a series of channels 116. The combination of protrusions 114 and channels 116 can provide a gripping surface for the user. In some embodiments, the outer body 102 may not include the combination of the protrusions 114 and the channels 116.

In some embodiments, the outer body 102 can be made of a metal material. In some embodiments, the outer body 102 can be made of a non-metal material. In some embodiments, the inner body 104 can be made of a metal material. In some embodiments, the inner body 104 can be made of a non-metal material. In some embodiments, the outer body 102 and the inner body 104 can be made of the same material. In some embodiments, the outer body 102 and the inner body 104 can be made of different materials. In some embodiments, the outer body 102 can be made of a metal material and the inner body 104 can be made of a non-metal material. In some embodiments, the outer body 102 can be made of a non-metal material and the inner body 104 can be made of a metal material.

In some embodiments, the outer body 102, the inner body 104, or a combination thereof, can be produced by an additive manufacturing process such as 3D printing.

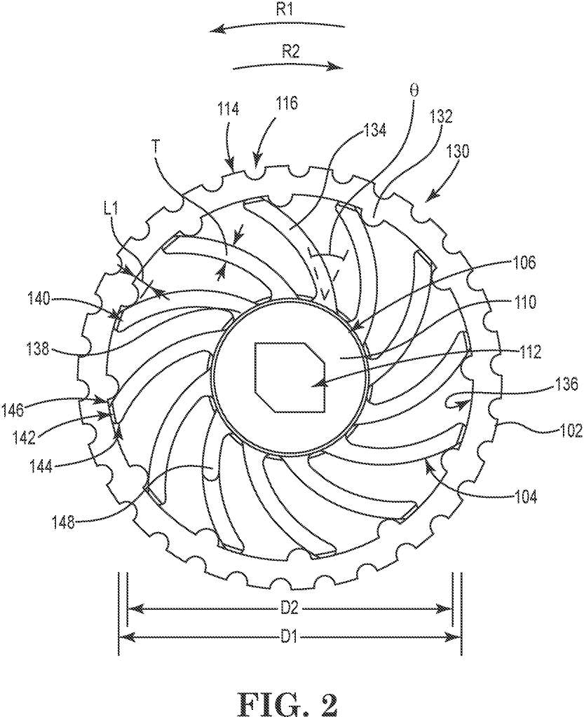

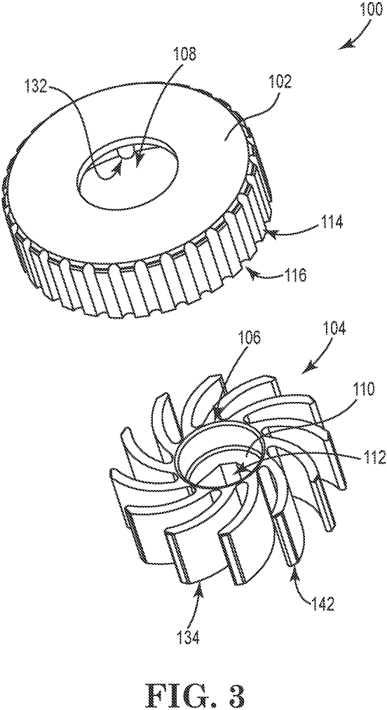

FIG. 2 shows a bottom view of the handle 100 of FIG. 1, according to some embodiments. FIG. 3 shows an exploded perspective view of the handle 100 of FIG. 1, according to some embodiments.

With reference to FIGS. 2-3 collectively, a torque limiting device 130 is visible in the bottom view, according to some embodiments.

As illustrated, the torque limiting device 130 includes a plurality of driving members 132 and a plurality of driven members 134. In the illustrated embodiment, the driving members 132 are integrally formed with the outer body 102 and the driven members 134 are integrally formed with the inner body 104. It is to be appreciated that in some embodiments, the driving members 132 can be integrally formed with the inner body 104 and the driven members 134 can be integrally formed with the outer body 102.

The outer body 102 has an inner diameter D1. The inner diameter D1 can be measured from an inner surface 136 of the outer body 102. In some embodiments, the driving members 132 extend a distance L1 from the inner surface 136. In certain embodiments, D1 can be at least about 1″ [25.4 mm], or less than or equal to 2.75” [70 mm], in other embodiments D1 can be approximately 1.75” [44.5 mm], wherein D1 can be scaled based on the application. The distance L1 can be selected in accordance with a dimensioning of the driving members 132. L1 can be scaled depending on the application. In certain embodiments L1 can range between 0.02” [0.5 mm] and 0.2” [5 mm], in other embodiments it can be approximately 0.05” [1.3 mm]. In the illustrated embodiment, the driving members 132 are shown as being semicircular in geometry. It is to be appreciated that this geometry can be modified in accordance with the principles disclosed in the Specification.

In some embodiments, the driven members 134 can include a base 138 and a tip 140. The base 138 is located at the hub 106. The tip 140 is a free end of the driven members 134. The tip 140 includes a surface 142. The surface 142 is configured to be adjacent to the inner surface 136. In some embodiments, the surface 142 is configured to engage with the inner surface 136. In some embodiments, the surface 142 is configured to be spaced from the inner surface 136 and to not contact the inner surface 136 except at the driving members 132. Accordingly, in some embodiments, the inner body 104 has an outer diameter D2 measured at the surface 142 of the tip 140. In some embodiments, the inner diameter D1 is larger than the outer diameter D2. In some embodiments, the inner diameter D1 and the outer diameter D2 are substantially the same. As used herein, substantially the same means the same subject to, for example, manufacturing tolerances or the like.

The driven members 134 include a first surface 144 and a second surface 146. The driving members 132 are configured to contact the second surface 146 of the driven members 134 when the handle 100 is rotated in the R1 direction. In some embodiments, the R1 direction corresponds to a closing direction of a valve. In response to being rotated in the R1 direction, the driving members 132 contact the driven members 134 and force the driven members 134 to rotate in the R1 direction. Upon reaching a torque threshold, the driving members 132 are configured to disengage from the driven members 134. As a result, the driving members 132 rotate in the R1 direction but the driven members 134 do not rotate in the R1 direction.

In some embodiments, to accomplish the disengagement, the driven members 134 are flexible. The driven members 134 can be flexible due to the materials selected. In some embodiments, the flexibility can be a result of a curvature of the driven members 134. To configure the torque limiting device 130 for a particular torque threshold, the stiffness of the material for the driven members 134 can be selected in combination with a thickness T of the driven members 134, an angle θ of the driven members 134, a radius of curvature of the 134, or the like.

In some embodiments, the torque threshold can be selected based on a particular valve being used with the handle 100. In some embodiments, the torque threshold can be based on an acceptable range of torques for a variety of valves. That is, in some embodiments, the handle 100 can be configured for a specific valve and in some embodiments the handle 100 can be configured for a series of valves.

In some embodiments, when the driving members 132 disengage from the driven members 134, feedback is provided to the user turning the handle 100. In some embodiments, the feedback is audible. For example, a clicking sound may be generated due to the disengagement of the driving members 132 and the driven members 134. In some embodiments, the feedback is tactile. For example, the user may feel the movement of the driven members 134 relative to the driving members 132. In some embodiments, the feedback is both audible and tactile.

In some embodiments, when the handle 100 is rotated in the R2 direction the driving members 132 are configured to contact the first surface 144 of the driven members 134. In In some embodiments, the R2 direction corresponds to an opening direction of a valve.

In some embodiments, the inner body 104 can include a member 148. The member 148 can protrude from the hub 106. In some embodiments, a corresponding member can be included on the valve so that a user cannot open the valve too far (i.e., over rotate in the R2 direction). Such a feature can serve as a stop for the rotation in the R2 direction and prevent damage to the valve from opening the valve beyond its fully open position.

In some embodiments, the torque threshold can be set based on one of the R1 direction or the R2 direction. In some embodiments, a first torque threshold can be set for the R1 direction and a second torque threshold can be set for the R2 direction. In some embodiments, the first torque threshold and the second torque threshold can be different.

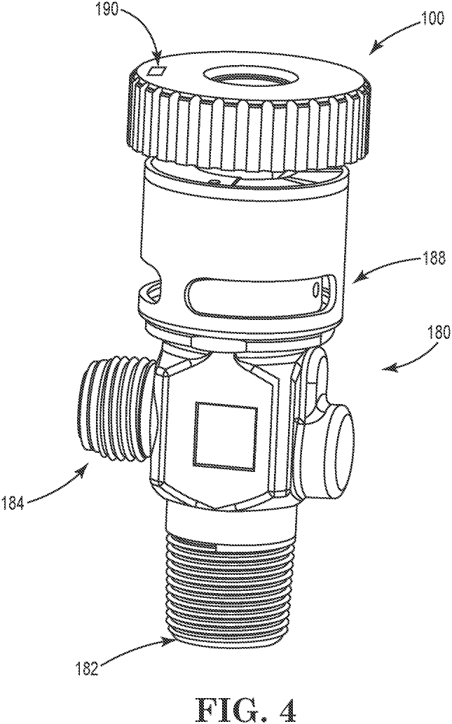

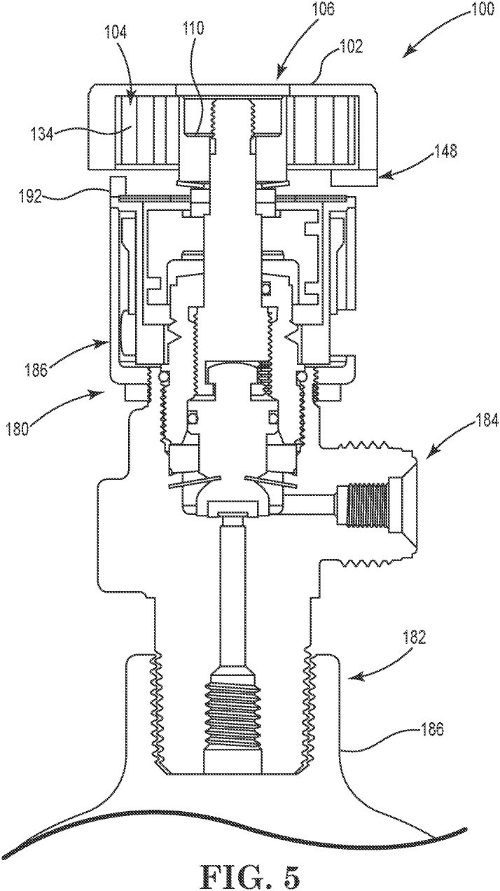

FIG. 4 shows a perspective view of the handle 100 of FIG. 1 installed on a valve 180, according to some embodiments. FIG. 5 shows a side sectional view of the handle 100 of FIG. 1 installed on the valve 180, according to some embodiments. Reference will be made to FIGS. 4-5 collectively unless specifically noted otherwise.

The valve 180 can include a first threaded connection 182 and a second threaded connection 184. The first threaded connection 182 and the second threaded connection 184 can be used to connect the valve 180 to a fluid container 186 and a device, respectively.

The valve 180 can include an indicator 188. In the illustrated embodiment, the indicator 188 shows that the valve 180 is in the “closed” state. In some embodiments, when a user rotates the handle 100 to transition from the “closed” state to an “opened” state, the indicator 188 can visually be modified to indicate “opened.” In some embodiments, the indicator 188 can include text similar to the illustrated embodiment. In some embodiments, the indicator 188 can include an “O” or a “C” for opened or closed, respectively. In some embodiments, the indicator 188 may not include any text and can instead include color coding. For example, in the closed state the indicator 188 can be red and in the opened state the indicator 188 can be green. It is to be appreciated that these colors are examples, and the actual colors can vary beyond the above example. In some embodiments, the indicator 188 can be configured to rotate along with the handle 100 and the valve 180. As such, in a partially opened or partially closed state, the indicator 188 may show an indication that the valve 180 is in an intermediate state.

In some embodiments, the handle 100 can include an indicator 190. The indicator 190 can be a scannable indicator. In some embodiments, the indicator 190 can be scanned by a device to determine a type of fluid being stored in the associated fluid container. In some embodiments, the 188 can be a barcode, QR code, or the like. In some embodiments, the indicator 190 can be an RFID tag or the like. In some embodiments, the indicator 190 can be a visual color coding that is indicative of the fluid contained within the fluid container.

In some embodiments, the valve 180 can include a member 192. The member 192 can be configured to engage with the member 148 (FIG. 2) when the valve 180 is in the opened state. The member 192 can prevent a user from over-rotating the handle 100. This can reduce a likelihood of the valve 180 being stuck in the opened state.

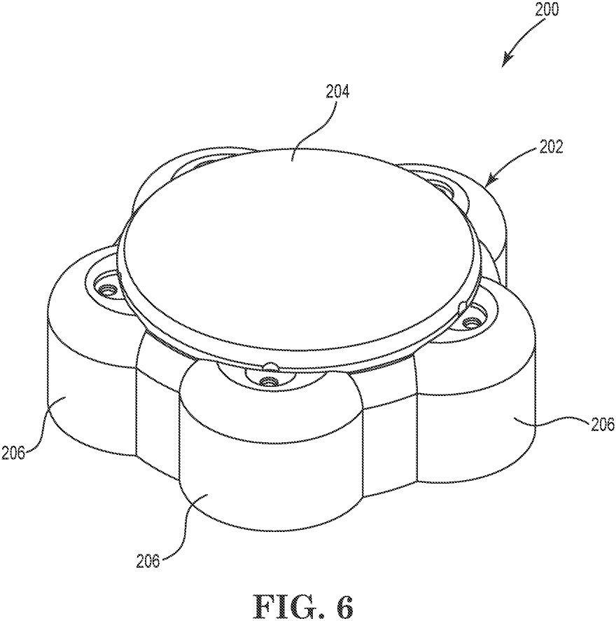

FIG. 6 shows a perspective view of a handle 200, according to some embodiments. In some embodiments, the handle 200 can be referred to as a torque limiting handle. In some embodiments, the handle 200 includes a torque limiting device. In some embodiments, the torque limiting device is configured to prevent a user from over torquing a valve when the handle 200 is used with a valve.

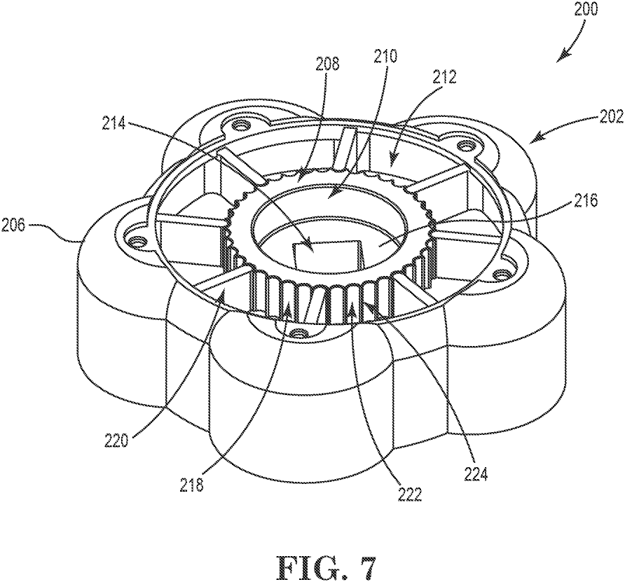

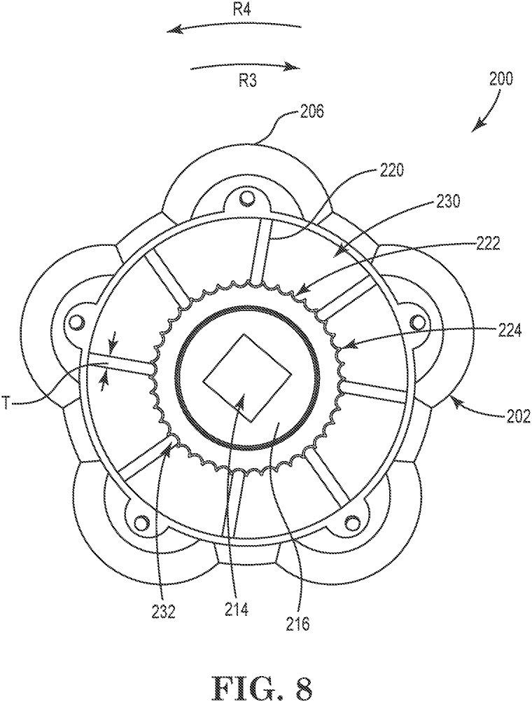

The handle 200 includes an outer body 202 and an inner body covered by a cover 204. The inner body is shown and described in additional detail in accordance with FIGS. 7-8 below. The cover 204 can be a separate piece from the outer body 202. In some embodiments, the outer body 202 can include a plurality of protruding members 206. The members 206 can provide a gripping surface for a user. In the illustrated embodiment, the handle 200 includes five of the members 206. It is to be appreciated that this is an example and the actual number of the members 206 can vary above or below five.

FIG. 7 shows a perspective view of the handle 200 of FIG. 6 with the cover 204 removed, according to some embodiments.

With the cover 204 removed, an inner body 208 is visible. The inner body 208 includes a hub 210. The hub 210 forms an inner opening 212. The inner body 208 is disposed in a location so that a threaded bolt from a valve can be received through an opening 214. In some embodiments, a nut or other fastener can be threaded to the corresponding bolt and subsequently secure the handle 200 to the valve. In some embodiments, the nut can be in direct contact with a surface 216 to provide a clamping force to hold the handle 200 to the valve. In some embodiments, the nut can be indirectly in contact with the surface 216 to provide the clamping force.

An outer surface of the inner body 208 can include a plurality of driven members 218 and the outer body 202 includes a plurality of driving members 220. The driving members 220 are sized and shaped to fit within the driven members 218. In some embodiments, the driven members 218 may be recessed into an outer surface of the inner body 208. For example, the inner body 208 includes a plurality of channels 222 recessed into an outer surface of the inner body 208. In some embodiments, protruding edges 224 define the channels 222 therebetween. In the illustrated embodiment, the channels 222 have a generally semicircular geometry. It is to be appreciated that this is an example, and the actual geometry can vary according to the principles described in this Specification. In some embodiments, the inner body 208 can have an appearance of a gear or sprocket.

The outer body 202 is rotatable relative to the inner body 208 in some situations. For example, when the handle 200 is turned to close a valve, the outer body 202 may disengage from the inner body 208 upon reaching a torque threshold. In some embodiments, the torque threshold can be selected based on a particular valve being used with the handle 200. In some embodiments, the torque threshold can be based on an acceptable range of torques for a variety of valves. That is, in some embodiments, the handle 200 can be configured for a specific valve and in some embodiments the handle 200 can be configured for a series of valves. In some embodiments, when the torque threshold is reached, feedback can be provided to the user. For example, in some embodiments audible feedback can be provided. In some embodiments, tactile feedback can be provided. In some embodiments, the feedback can be both audible and tactile.

In some embodiments, the outer body 202 can be made of a metal material. In some embodiments, the outer body 202 can be made of a non-metal material. In some embodiments, the inner body 208 can be made of a metal material. In some embodiments, the inner body 208 can be made of a non-metal material. In some embodiments, the outer body 202 and the inner body 208 can be made of the same material. In some embodiments, the outer body 202 and the inner body 208 can be made of different materials. In some embodiments, the outer body 202 can be made of a metal material and the inner body 208 can be made of a non-metal material. In some embodiments, the outer body 202 can be made of a non-metal material and the inner body 208 can be made of a metal material.

In some embodiments, the outer body 202, the inner body 208, or a combination thereof, can be produced by an additive manufacturing process such as 3D printing.

FIG. 8 shows a top view of the handle 200 of FIG. 6 with the cover removed, according to some embodiments.

The driven members 218 and driving members 220 can be collectively referenced as a torque limiting device 230.

In the illustrated embodiment, the driving members 220 are integrally formed with the outer body 202 and the driven members 218 are integrally formed with the inner body 208.

A tip 232 of the driving members 220 is configured to be received in the channels 222 of the driven members 218. The driving members 220 are configured to contact the edges 224 of the driven members 218 when the handle 200 is rotated in the R3 direction or the R4 direction. In some embodiments, the R3 direction corresponds to a closing direction of a valve. In response to being rotated in the R3 direction, the driving members 220 contact the driven members 218 and force the driven members 218 to rotate in the R3 direction. Upon reaching a torque threshold, the driving members 220 are configured to disengage from the driven members 218. As a result, the driving members 220 rotate in the R3 direction but the driven members 218 do not rotate in the R3 direction.

In some embodiments, the torque threshold can be set based on one of the R3 direction or the R4 direction. In some embodiments, a first torque threshold can be set for the R3 direction and a second torque threshold can be set for the R4 direction. In some embodiments, the first torque threshold and the second torque threshold can be different.

In some embodiments, to accomplish the disengagement, the driving members 220 are flexible. The driving members 220 can be flexible due to the materials selected. To configure the torque limiting device 230 for a particular torque threshold, the stiffness of the material for the driving members 220 can be selected in combination with a thickness T of the driving members 220, a number of the driving members 220, or the like.

In some embodiments, the torque threshold can be selected based on a particular valve being used with the handle 200. In some embodiments, the torque threshold can be based on an acceptable range of torques for a variety of valves. That is, in some embodiments, the handle 200 can be configured for a specific valve and in some embodiments the handle 200 can be configured for a series of valves.

In some embodiments, when the driving members 220 disengage from the driven members 218, feedback is provided to the user turning the handle 200. In some embodiments, the feedback is audible. For example, a clicking sound may be generated due to the disengagement of the driving members 220 and the driven members 218. In some embodiments, the feedback is tactile. For example, the user may feel the movement of the driven members 218 relative to the driving members 220. In some embodiments, the feedback is both audible and tactile.

In some embodiments, when the handle 200 is rotated in the R4 direction the driving members 220 are configured to contact the edges 224 of the driven members 218. In In some embodiments, the R4 direction corresponds to an opening direction of a valve. In some embodiments of the invention, the torque limiting device is on a valvue used for a fluid storage and dispensing device.

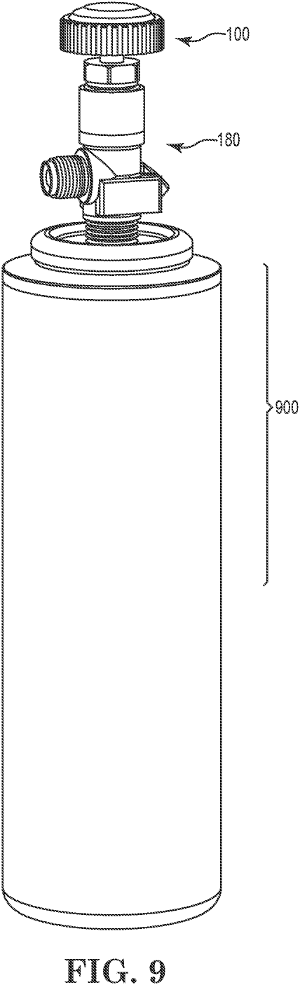

FIG. 9 shows the torque limiting device 100 attached to a valve on a fluid storage and dispensing vessel 900, in accordance to some embodiments. Examples of the fluid storage and dispensing packages include packages commercially available under the SDS and SAGE trademarks from Entegris, Inc. (Billerica, Massachusetts, USA) in which fluid is stored on an adsorbent medium, from which it is desorbed under dispensing conditions, and packages commercially available under the VAC trademark from Entegris, Inc. in which the fluid storage and dispensing vessel contains an interiorly disposed pressure regulator assembly arranged to open in response to a downstream pressure below the set point of the regulator assembly, so that fluid is dispensed at the set point pressure.

Fluid stored in and dispensed from the fluid supply package of the disclosure may be of any suitable type, and may for example comprise a fluid having utility in semiconductor manufacturing, manufacture of flat-panel displays, or manufacture of solar panels.

Nonlimiting examples of fluid contained in the fluid storage and dispensing vessel may for example comprise a hydride fluid for semiconductor manufacturing operations. Examples of hydride fluids of such type include arsine, phosphine, stibine, silane, chlorosilane, diborane, germane, disilane, trisilane, methane, hydrogen selenide, hydrogen sulfide, and hydrogen. Other fluids useful in semiconductor manufacturing operations may be employed, including acid fluids such as hydrogen fluoride, boron trichloride, boron trifluoride, diboron tetrafluoride, hydrogen chloride, halogenated silanes (e.g., SiF4) and disilanes (e.g., Si2F6), GeF4, PF3, PF5, AsF3, AsF5, He, N2, O2, F2, Xe, Ar, Kr, CO, CO2, CF4, CHF3, CH2F2, CH3F, NF3, COF2, as well as mixtures of two or more of the foregoing, etc., having utility in semiconductor manufacturing operations as halide etchants, cleaning agents, source reagents, etc. Other reagents which may be thus stored and delivered include gaseous organometallic reagents used as precursors for metalorganic chemical vapor deposition (MOCVD) and atomic layer deposition (ALD).

In other embodiments of the invention, the torque limiting device can be on a valve for a gas storage and dispensing vessels. The gas stored in and dispensed from the pressure-regulated vessels of the disclosure may be of any suitable type, and may for example comprise gases useful in the manufacture of semiconductor products, flat-panel displays, and solar panels. Such gases may include single component gases as well as multicomponent gas mixtures.

Illustrative gases that may be contained in the pressure-regulated gas supply package of the disclosure include, without limitation, arsine, phosphine, nitrogen trifluoride, boron trifluoride, boron trichloride, diborane, trimethylsilane, tetramethylsilane, disilane, silane, germane, organometallic gaseous reagents, hydrogen selenide, hydrogen telluride, stibine, chlorosilane, germane, disilane, trisilane, methane, hydrogen sulfide, hydrogen, hydrogen fluoride, diboron tetrafluoride, hydrogen chloride, chlorine, fluorinated hydrocarbons, halogenated silanes (e.g., SiF4) and disilanes (e.g., Si2F6), GeF4, PF3, PF5, AsF3, AsF5, He, N2, O2, F2, Xe, Ar, Kr, CO, CO2, CF4, CHF3, CH2F2, CH3F, NF3, COF2, etc., as well as mixtures of two or more of the foregoing, and isotopically enriched variants thereof.

The gas storage and dispensing vessel may contain gas in the interior volume of the vessel container, and such gas may be a single component gas or a multicomponent gas, and may for example comprise gas selected from the group consisting of arsine, phosphine, nitrogen trifluoride, boron trifluoride, boron trichloride, diborane, trimethylsilane, tetramethylsilane, disilane, silane, germane, organometallic gaseous reagents, hydrogen selenide, hydrogen telluride, stibine, chlorosilane, germane, disilane, trisilane, methane, hydrogen sulfide, hydrogen, hydrogen fluoride, diboron tetrafluoride, hydrogen chloride, chlorine, fluorinated hydrocarbons, halogenated silanes, SiF4, halogenated disilanes, Si2F6, GeF4, PF3, PF5, AsF3, AsF5, He, N2, O2, F2, Xe, Ar, Kr, CO, CO2, CF4, CHF3, CH2F2, CH3F, NF3, COF2, mixtures of two or more of the foregoing, and isotopically enriched variants of the foregoing.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A handle, comprising:
a torque limiting device comprising:
a plurality of driven members; and
a plurality of driving members,
wherein the plurality of driving members is configured to drive the plurality of driven members in a first direction to turn a valve;
wherein in response to turning the valve, the plurality of driving members disengages from the plurality of driven members upon reaching a torque threshold;
wherein feedback is provided when the torque limiting device reaches the torque threshold.

2. The handle of claim 1, wherein the handle is configured to be turned in the first direction to close the valve and to be turned in a second direction to open the valve, wherein the handle further comprises an indicator configured to visually indicate a position of the valve.

3. The handle of claim 1, further comprising an outer body and an inner body, wherein the outer body and the inner body are configured to be joined together, wherein the inner body is configured to be secured within the outer body.

4. The handle of claim 3, wherein the outer body includes the plurality of driving members and the inner body includes the plurality of driven members.

5. The handle of claim 3, wherein the outer body includes the plurality of driven members and the inner body includes the plurality of driving members.

6. The handle of claim 3, wherein one or more of the outer body and the inner body are made of a non-metal material.

7. The handle of claim 3, wherein the outer body has an inner diameter, and the inner body has an outer diameter, wherein the inner diameter is larger than the outer diameter so that the inner body fits within the outer body.

8. The handle of claim 3, wherein the plurality of driven members includes a plurality of members extending from a hub of the inner body.

9. The handle of claim 1, wherein a geometry and stiffness of the plurality of driving members are defined to cause the plurality of driving members to be disengaged from the plurality of driven members upon reaching the torque threshold.

10. A system, comprising:
a fluid or gas storage and dispensing vessel;
a valve,
wherein the valve has a first position in which flow from the fluid container is enabled;
wherein the valve has a second position in which flow from the fluid container is disabled; and
a handle configured to be turned in a first direction to open the valve and to be turned in a second direction to close the valve, the handle comprising:
a plurality of driven members; and
a plurality of driving members,
wherein the plurality of driving members is configured to drive the plurality of driven members in a first direction to turn the valve;
wherein in response to turning the valve, the plurality of driving members disengages from the plurality of driven members upon reaching a torque threshold;
wherein feedback is provided when the torque threshold is reached.

11. The system of claim 10, further comprising an indicator configured to visually indicate a position of the valve.

12. The system of claim 10, further comprising a scannable indicator configured to denote a fluid type of the fluid container.

13. The system of claim 12, wherein the handle includes the scannable indicator.

14. The system of claim 10, wherein one or more of the plurality of driving members and the plurality of driven members are made of a non-metal material.

15. The system of claim 10, wherein the handle further comprises an outer body and an inner body, wherein the outer body and the inner body are configured to be joined together, wherein the inner body configured to be secured within the outer body, wherein the outer body has an inner diameter, and the inner body has an outer diameter, wherein the inner diameter is larger than the outer diameter so that the outer body fits over the inner body.

16. The system of claim 10, wherein a geometry and stiffness of the plurality of driving members are defined to cause the plurality of driving members to be disengaged from the plurality of driven members upon reaching the torque threshold.

17. The system of claim 10, wherein the plurality of driven members includes a plurality of members extending from a hub of the handle.

18. The system of claim 10, wherein the handle further comprises a protrusion.

19. The system of claim 18, wherein at least one of the valve and the fluid container comprises a second protrusion, wherein the second protrusion is configured to limit an amount of rotation in the first direction through abutment with the protrusion of the handle.

20. The system of claim 11, wherein a force applied by the plurality of driving members to the plurality of driven members is configured to be different in the first direction than the second direction.
